(19) United States
(12) Patent Application Publication
(10) Pub. No.: US 2017/0248111 A1
(43) Pub. Date: Aug. 31, 2017

(54) PRESSURE REGULATING SOLENOID VALVE

(71) Applicant: Delphi International Operations Luxembourg S.A.R.L, Bascharage (LU)

(72) Inventors: Michel Marechal, Choussy-sur-Cisse (FR); Frederic Sauvage, Beaugency (FR); Alexis Menand, Blois (FR); Alain Amand, Blois (FR); Nicolas Cezon, Ingres (FR); Peter Voigt, Bettange-sur-Mess (LU)

(21) Appl. No.: 15/322,811

(22) PCT Filed: Jun. 15, 2015
(86) PCT No.: PCT/EP2015/063355

§ 371 Date: Feb. 21, 2017

(30) Foreign Application Priority Data
Jul. 1, 2014 (FR) 1456266

(51) Int. Cl. F02M 63/02; F16K 31/40; F16K 15/18

(52) U.S. Cl. CPC F02M 63/025; F16K 15/183; F16K 15/185; F16K 31/402; F02M 2200/302

(57) ABSTRACT

A solenoid valve which regulates the pressure in a pressurized fuel injection system includes a body containing a needle that is pressed by an electromagnet including a coil and a magnetic core. The core has a cavity that is in fluid communication via an internal channel with a counterbore in the body into which the needle protrudes and into which fuel flows during use. The core also has a restriction which restricts the fluid communication and which attenuates pressure waves propagating in the fuel to prevent the waves from moving the core.

### CROSS REFERENCE TO RELATED APPLICATIONS

This application is a national stage application under 35 USC 371 of PCT Application No. PCT/EP2015/063355 having an international filing date of Jun. 15, 2015, which is designated in the United States and which claimed the benefit of FR Patent Application No. 1456266 filed on Jul. 1, 2014 the entire disclosures of each are hereby incorporated by reference in their entirety.

### TECHNICAL DOMAIN

The invention relates to a pressure regulating solenoid valve in a common rail of an injection system, notably for an internal-combustion engine.

### TECHNOLOGICAL BACKGROUND TO THE INVENTION

Diesel injection systems need to be operational over a wide pressure range covering several thousand bars and a wide temperature range covering the northern winter and the southern summer. The system is provided with a controlled solenoid valve that adjusts the pressure in the common rail of the system to within a few bars. However, pressure waves propagate in the fuel and can disturb the correct operation of said solenoid valve. Said solenoid valve is provided with means for attenuating such waves, notably channels for recirculating some of the fuel between the output of the common rail and the magnetic core of the solenoid valve.

Unfortunately, such attenuation only works on a limited portion of the pressure range and disturbances may appear outside of this portion, preventing the optimal operation of the solenoid valve and of the system.

### SUMMARY OF THE INVENTION

The present invention is intended to at least partially address these problems by proposing a solenoid valve that is designed to regulate the pressure in a pressurized fuel injection system. The solenoid valve includes a body containing a needle sliding between a closed position and an open position, the needle being pressed by an electromagnet including a coil rigidly connected to the body and a magnetic core that is movable axially between a first position in which the magnetic core presses the needle into the closed position and a second position in which the needle is free to move to the open position. The core is provided with a cavity that is in fluid communication via an internal channel with a counterbore in the body into which the needle protrudes and into which fuel flows during use.

The core is also provided with means for restricting said fluid communication that are designed, during use, to attenuate the pressure wave propagating in the fuel and to prevent said waves from moving the core.

The restriction means are a device designed to naturally block the fluid communication, said device, when in use, closing said communication if a pressure wave propagating in the fuel attempts to move the core to the second position.

According to one embodiment, the device is a check valve including a ball placed in the channel and a valve seat against which the ball can be positioned to block the channel.

According to another embodiment, the device includes an elastic member that, when in use, blocks the channel if the core is pushed by a pressure wave towards the second position, thereby preventing said movement, the elastic member opening the channel by bending under the influence of the movement of the core when this latter moves towards the first position.

More specifically, the elastic member is a membrane attached to the bottom of the cavity.

According to another embodiment, the elastic member is a diaphragm including flexible arms, one end of which is attached to the bottom of the cavity, while the other movable end is positioned at the output of the channel. According to an alternative, the movable end of the diaphragm only partially obstructs the channel so that the fuel retained in the cavity can exit same via a limited fuel flow.

### DESCRIPTION OF THE FIGURES

An embodiment of the invention is described below using the following figures.

FIG. 1 is an axial cross section of a pressure regulating solenoid valve known in the prior art.

FIGS. 2, 3, 4 and 5 are details of a solenoid valve according to three embodiments of the invention.

FIGS. 6 and 7 show a check diaphragm such as the one used in the solenoid valve in FIG. 5.

### DESCRIPTION OF PREFERRED EMBODIMENTS

In a diesel injection system 10, it is known to arrange a solenoid valve 14 at the end of a common rail 12 with a plurality of injectors, said solenoid valve 14 being used to regulate the pressure of the fuel in the rail 12. The application chosen to illustrate the invention is part of the diesel system. However, the subject matter of the invention is not dependent on fuel type and may be used as part of an injection system for petrol or any other fuel.

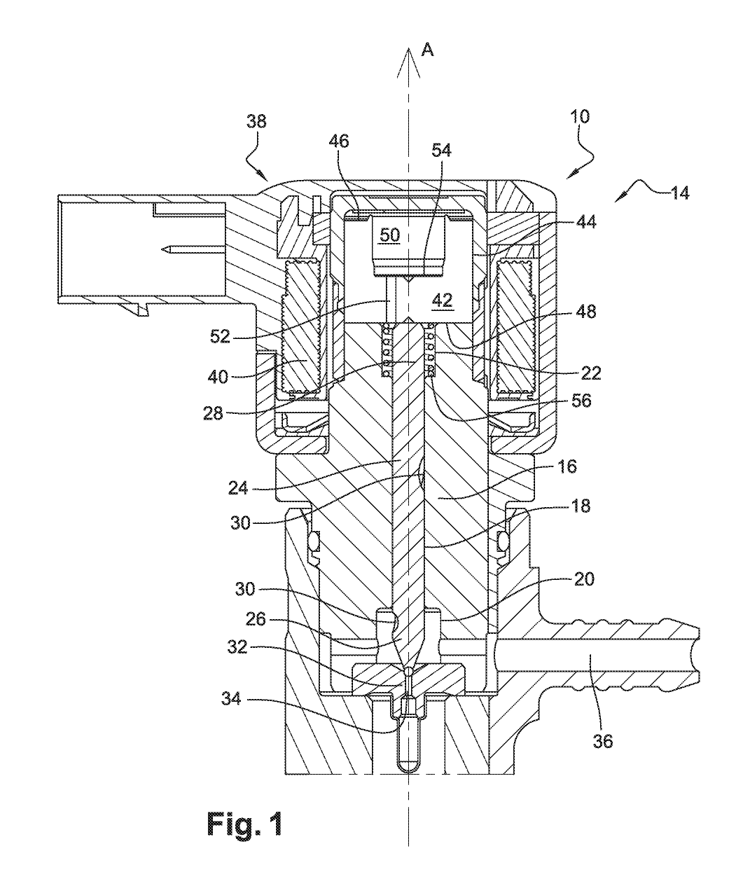

A solenoid valve 14 known in the prior art is described below with reference to FIG. 1, using the top-down orientation shown in the figure for the sake of clarity of the description, without thereby limiting same.

The solenoid valve 14 extends along a main axis A and includes a body 16 designed to fit the end of the rail 12. There are multiple alternatives to this arrangement that are not detailed here.

The body 16 has an axial borehole 18 opening out at the ends of the body into a lower counterbore 20 and into an upper counterbore 22, said borehole 18 containing a sliding needle 24, the tip 26 of which protrudes into the lower counterbore 20 and, conversely, the head 28 protrudes into the upper counterbore 22. The needle has a helical groove 30 running from the tip 26 to the head 28.

Thus arranged, the needle 24 can move in the borehole 18 between a closed position PF and an entirely open position PO. In the closed position PF, the tip 26 of the needle 24 butts against a valve seat 32 and blocks an output orifice 34 keeping the fuel inside the common rail 12 and, in the open position PO, the tip 26 is withdrawn from the seat 32, the orifice 34 is opened and the pressurized fuel can exit the rail 12 to flow into a return channel 36.

The solenoid valve in FIG. 1 includes a specific arrangement of the seat 32 positioned in another counterbore of the body 16 with a small ball placed between the seat 32 and the tip 26 of the needle 24, and a return channel 36 arranged laterally. There are very many alternatives to this arrangement that are also not detailed above.

At the end opposite the seat 32, at the top of the figure, the solenoid valve 14 has an electromagnet 38 attached to the top of the body 18. The electromagnet includes a coil 40 connected to an electronic controller (not shown) and a movable magnetic core 42 that cooperates with the head 28 of the needle 24. The coil 40 is rigidly connected to the body 16, is ring shaped and surrounds the top of the body 16. At the center of the coil there is an axial seat 44 in which the magnetic core 42 is arranged in line with the body 16 and the needle 24. The magnetic core 42 is cylindrical, extending axially A between an upper face 46 and a lower face 48, and has a cavity 50 in the form of a cylindrical counterbore opening out onto the upper face 46, and a channel 52 linking the bottom 54 of the cavity 50 to the lower face 48 of the core 42. A single channel 52 is described and illustrated here. Nonetheless, alternatives including a plurality of channels 52 also exist.

Inside the seat 44, the magnetic core 42 can slide between a low position PB, adopted when the coil 40 is powered electrically, and a high position PH, adopted when the coil 40 is not powered. A spring 56 is compressed between the bottom of the upper counterbore 22 and the lower face 48 of the core 42, said spring 56 permanently pressing the core 42 towards the high position PH.

Operation of the solenoid valve 14 is described below.

If the pressure of the fuel in the common rail 12 is below a predetermined limit stored in the electronic controller, the coil 40 is powered and presses the core 42 into the low position PB. The lower face 48 of the core bears against the head 28 of the needle 24 and holds same in the closed position PF. If the pressure in the common rail 12 reaches said predetermined limit, the power to the coil 40 is stopped and the core 42 moves to the high position PH, pressed simultaneously by the spring 56 and also by the needle 24, which is pushed into the open position PO by the pressurized fuel coming out of the output orifice 34. Most of the fuel is then discharged via the return channel 36, while a lesser portion passes between the needle 24 and the borehole 18, notably following the helical groove 30. This fuel moves upwards towards the upper counterbore 22, then the channel 52 inside the core 42, and finally the cavity 50. When the coil 40 is being powered again, the core 42 returns to the low position PB and the portion of the fuel that had moved up towards the core can flow in the opposite direction towards the return channel 36.

When in use, the pressure of the fuel must be kept within a range of ±15 bars, while the nominal pressure varies between approximately 200 bars and approximately 2500 bars, the fuel flow rate varies between approximately 5 L/h and approximately 120 L/h and the temperature of the fuel varies between −30° C. and +110° C. The channel 52 is the mentioned such that, at low temperatures, the response time of the solenoid valve is less than one half second. However, the portion of the fuel flowing towards the core carries pressure waves that disturb the movements commanded by the core 42.

A check valve is arranged in the core to mitigate the effects of these waves.

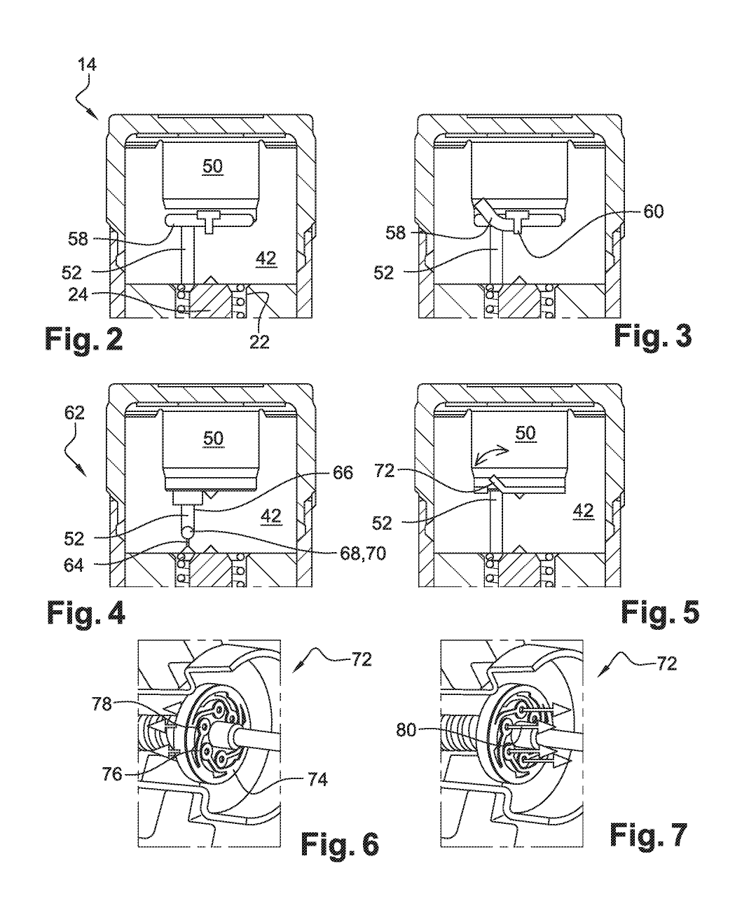

A first embodiment is described below with reference to FIGS. 2 and 3.

An elastic membrane 58 is arranged at the bottom 54 of the cavity 50, said elastic membrane 58 fitting the bottom 54 of the cavity 50 and obstructing the channel 52 when idle. The example chosen shows a membrane 58 attached at the center of same to the bottom 54 of the cavity 50 by a pin 60. However, the attachment method may be replaced by a screw or any other alternative attachment method, including adhesive, as required. Furthermore, the attachment shown here is central, but may be moved towards one side of the cavity. When a pressure wave rises and reaches the upper counterbore 22 beneath the magnetic core 42, said pressure wave presses the core towards the high position PH. In response to this movement, the membrane 58 is pressed against the bottom 54 of the cavity 50 and blocks the channel 52. Since the cavity 50 and all of this top space of the valve in general is full of incompressible liquid, blocking the channel 52 results in a sudden increase in the pressure inside the cavity 50, which prevents the core 42 from moving upwards.

A second embodiment is described below with reference to FIG. 4.

The channel 52 includes a check valve 62 formed as follows: the channel 52 includes a first “lower” portion 64 of smaller section and a second “upper” portion 66 of larger section. The lower portion 64 extends towards the cavity 50 from the lower face 48 of the core, while the upper portion 66 extends towards the lower face 48 from the bottom 54 of the cavity 50. The intersection of the lower portion 64 and the upper portion 66 forms a conical section defining a valve seat 68. A ball 70 arranged in the upper portion 66 is free to move therein and, as shown in the figure, the ball 70 rests when idle against the valve seat 68 and blocks the lower portion 64 of the channel 52. A spring (not shown) may be placed in the upper portion 66 to permanently press the ball 70 against the seat 68.

Operation is similar to operation of the membrane 58 in the first embodiment. When a pressure wave rises and reaches the upper counterbore 22 beneath the magnetic core 42, said pressure wave presses the core towards the high position PH. In response to this movement, the ball 70 is pressed against the valve seat 68 and closes the channel 52, which prevents the core 42 from moving upwards for the same reasons as specified above.

A third embodiment is described below with reference to FIGS. 5, 6 and 7.

An elastic diaphragm 72 known as a reed valve is placed at the bottom 54 of the cavity 50. The diaphragm 72 is formed in a thin metal sheet and includes an outer disk 74 from which arms 76 extend inwards. In order to increase the flexibility of the arms 76, the arms 76 are both narrow and relatively long. Thus, as shown in FIGS. 6 and 7, the arms 76 are curved, extend nearly tangentially to the disk 74 and coil round to a circular distal end 78 that is perforated at the center 80 of same. According to the figures, the disk 74 is arranged at the periphery of the bottom 54 of the cavity 50 and the arm 76, when idle, extends such that the circular extremity 78 is positioned at the opening of the channel 52 and partially obstructs same, in consideration of the central hole 80.

Thus far, the description has disclosed a magnetic core 42 having a single channel 52 joining the lower face 48 to the bottom 54 of the cavity 50. Regardless of the embodiment selected (elastic membrane 58, check valve 62 or reed diaphragm 72), the core may have a plurality of channels 52 and a person skilled in the art would be able to adapt each of the embodiments with one or more channels 52 without difficulty. Thus, the diaphragm 72 shown is clearly provided to block a plurality of channels 52 (six in the figure).

Operation of the diaphragm 72 is explained below. When a pressure wave rises and reaches the upper counterbore 22 beneath the magnetic core 42, said pressure wave presses the core towards the high position PH. In response to this movement, the circular end 78 is moved against the inlet of the channel 52 and blocks the channel 52, which prevents the core 42 from moving upwards for the same reasons as specified above.

In the alternative disclosed, the circular end 78 has a small central hole 80 such that the channel 52 is never completely blocked and a limited flow of fluid can always flow through the channel 52. This mitigates the effect of the pressure wave and reduces movement of the core.

The following reference signs have been used in the description:

10 Injection system

12 Common rail

14 Solenoid valve

16 Body of the solenoid valve

18 Borehole

20 Lower counterbore

22 Upper counterbore

24 Needle

26 Tip of the needle

28 Head of the needle

30 Helical groove

32 Valve seat

34 Output orifice

36 Return channel

38 Electromagnet

40 Coil

42 Magnetic core

44 Coil seat

46 Upper face of the core

48 Lower face of the core

50 Cavity in the core

52 Channel

54 Bottom of the cavity

56 Spring

58 Elastic membrane

60 Attachment pin

62 Check valve

64 Lower portion of the channel

66 Upper portion of the channel

68 Valve seat

70 Ball

72 Elastic reed diaphragm

74 Outer disk

76 Ann

78 Circular end

80 Central hole

A Main axis

PF Closed position

PO Open position

PB Low position of the core

PH High position of the core

1-7. (canceled)

8. A solenoid valve which regulates the pressure in a pressurized fuel injection system, the solenoid valve comprising:
a body;
a needle contained in the body such that the needle slides between a closed position and an open position;
an electromagnet which presses the needle, the electromagnet including a coil rigidly connected to the body and a magnetic core that is movable axially between a first position in which the magnetic core presses the needle into the closed position and a second position in which the needle is free to move to the open position, the magnetic core having a cavity that is in fluid communication via an internal channel with a counterbore in the body into which the needle protrudes and into which fuel flows during use, the core also having means for restricting said fluid communication to attenuate pressure waves propagating in the fuel and to prevent said pressure waves from moving the magnetic core.

9. The solenoid valve as claimed in claim 8, wherein the restriction means are a device which naturally blocks the fluid communication, said device closing the fluid communication when a pressure wave propagating in the fuel attempts to move the magnetic core to the second position.

10. The solenoid valve as claimed in claim 9, wherein the device is a check valve including a ball placed in the internal channel and a valve seat against which the ball can be positioned to block the internal channel.

11. The solenoid valve as claimed in claim 9, wherein the device includes an elastic member that blocks the internal channel when the magnetic core is pushed by a pressure wave towards the second position, thereby preventing said movement and opening same by bending under the influence of the movement of the magnetic core towards the first position.

12. The solenoid valve as claimed in claim 11, wherein the elastic member is a membrane attached to a bottom of the cavity.

13. The solenoid valve as claimed in claim 11, wherein the elastic member is a diaphragm including flexible arms, one end of which being attached to the bottom of the cavity and the other end being movable and positioned at an output of the channel.

14. The solenoid valve as claimed in claim 13, wherein the other end of the diaphragm only partially obstructs the channel so that the fuel retained in the cavity can exit the channel via a limited fuel flow.
